(19) United States
(12) Patent Application Publication
(10) Pub. No.: US 2007/0050846 A1
(43) Pub. Date: Mar. 1, 2007

(54) Logging method, system, and device with analytical capabilities for the network traffic

(75) Inventors: Ken Xie, Atherton, CA (US); Michael Xie, Palo Alto, CA (US); Bing Xie, Palo Alto, CA (US)

Correspondence Address: SUGHRUE MION, PLLC, 2100 PENNSYLVANIA AVENUE, N.W., SUITE 800, WASHINGTON, DC, 20037, US

(73) Assignee: FORTINET, INC., Sunnyvale, CA (US)

(21) Appl. No.: 11/213,719

(22) Filed: Aug. 30, 2005

(51) Int. Cl. G06F 12/14

(52) U.S. Cl. 726/22

(57) ABSTRACT

A logging device, system and a method for managing network packets. The logging device includes a traffic capturing device receiving the network packets and filtering the network packets by selecting some of the network packets based on a predefined criteria. The logging device also includes a storage device storing the selected network packets and an analyzing component organizing the stored network packets in accordance with a user specified parameters. The traffic capturing component, the storage component, and the analyzing component are integrated in a single physical device providing a user with an ability to monitor real-time network traffic on the fly. The traffic capturing component selects the network packets for storage based on source and destination addresses of the network packets, based on a protocol of the network packets, based on a port designated, and based on whether a particular traffic session matches a predetermined signature.

### FIELD OF THE PRESENT INVENTION

The present invention broadly relates to a method, a system, and a device for logging and analyzing network traffic.

### BACKGROUND OF THE INVENTION

Due to regulatory compliance, many companies are required to store the network traffic for a certain period of time. For example, the US 404 certification or HIPPA requires companies to keep the network traffic for 5-7 years. Usually, companies falling under these governmental regulations hire a separate vendor that uses network packet sniffer based technologies, which capture the network traffic. This network traffic is then stored in a designated storage area. Once the data is stored, various analyzers are provided to sort and archive the data and to dig out the desired information from the data. The packets are analyzed one by one to extract the desired data.

In the related art, the network traffic, the data exchanged between a client and a server or the client and another client, are visible to a so called network monitor. The network monitor, also referred to as a “packet sniffer,” sees the packets that are transmitted across the network and creates a trace. One of the commonly used packet sniffers is an open source code ETHEREAL® sniffer. ETHEREAL® also provides a number of various analyzers for the captured packets. By way of an example, the packet sniffers may be used for troubleshooting the network and application performance, monitoring network utilization, detecting physical network problems, locating security concerns, and capturing network traffic for analysis.

FIG. 1 depicts a system for capturing incoming traffic from the Internet. In particular, FIG. 1 depicts Internet 10 in which packets are transferred from various sources to their respective destinations. For example, if the internal network such as an organizational LAN (local area network) 13 is the respective destination of the transmitted packets, these packets are received by a firewall 11. The firewall 11 stands between internal network 13 and the Internet 10. The firewall 11 protects the internal network 13 by monitoring the arriving traffic. The traffic let through by the firewall 11 is transmitted to the router 12. The sniffer 14, on the other hand, captures the traffic transmitted from the firewall 11 to the router 12. The captured packets are then sent to the storage 15. Alternatively, the sniffer 14 can be positioned before the firewall 11 to capture all of the traffic packets designated for the internal network 13 or on the router 12 to capture network packets arriving at the router 12.

While the sniffer 14 is valuable for recording the activity on the network, it is a very poor tool for analyzing the activity because it does not understand the protocols in which the packets are transmitted e.g., the sniffers in the related art do not understand the HTML, XML, and other protocols. The network packets captured by the sniffers are displayed as a very user unfriendly jumble of bytes in what is known as the frame viewer window. The reading of the captured packets is further complicated when the data is chunked because the data is all strung together. Furthermore, the reading of the captured packets becomes even more complicated because of the interleaving of the transmitted packets. As such, upon desiring to read the portion of the captured packets specific to a given request and/or response, a reader easily confuses data that he/she believes corresponds to the given request and/or response with data that corresponds to other requests and/or responses.

In other words, one of the drawbacks of the related art techniques is that the packet sniffer trace is hard to search and to reconstruct the original content. For example, if the user wants to find out whether a particular email includes a combination of sensitive words, the user needs to find out all of the packets sent during that period, and reconstruct the packets for all of the email, and then search. In the related art, as explained above, the sniffers log the network traffic onto a storage device. The unsorted packets stored in the storage device are sequentially examined by the analyzers. Accordingly, to analyze the data traffic, each stored packet has to be examined sequentially, one by one.

Another drawback of the related art techniques is that the analyzers may set various criteria for analyzing the data packets. These criteria are pre-programmed. In the related art techniques, there is no flexibility of adjusting these criteria by the user.

Moreover, in the related art techniques, when using a sniffer to record the network packets, the CPU (central processing unit) and memory are intensively used. As a result, if the user is also trying to use this same computer to search for the previously recorded packets, it causes a CPU and memory overload. That is, it will take a long time to find the desired packets. Also, some of the packets could be missed in the sniffer as a result of this overload of resources.

In short, in the related art, the process of logging and analyzing network traffic is time consuming and costly.

### SUMMARY OF THE INVENTION

One object of the present invention is to provide a method, a system, and a device to achieve the logging and analyzing of the data traffic more efficiently. Another object of the present invention is to provide an integrated solution for logging and analyzing data. Yet, another object of the present invention is to provide the user with more flexibility in monitoring the network traffic. Further, it is an object of the present invention to allow a large amount of network data to be stored and analyzed without slowing down the network performance and overloading computer resources.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

Accordingly to an exemplary, non-limiting formulation of the present invention a logging device managing network packets is provided. The logging device includes a traffic capturing component receiving the network packets and filtering the network packets by selecting some of the network packets based on a predefined criteria, a storage component storing the selected network packets, and an analyzing component organizing the stored network packets in accordance with a user specified parameters. The traffic capturing component, the storage component, and the analyzing component are integrated in a single physical device.

According to yet another illustrative, non-limiting formulation of the present invention, a logging system managing network packets is provided. The logging system includes a gateway computer receiving the network packets. The gateway computer is configured to select some the received network packets based on: a source address of a network packet, a destination addresses of the network packet, a protocol of the network packet, a port selection, and whether a specific traffic session matches a predefined signature of the network packet. The logging system further includes a storage device storing the selected network packets and an analyzing computer organizing the stored network packets in accordance with a user specified parameters.

Another illustrative, non-limiting formulation of the present invention is a method for managing network packets. The method includes receiving network packets from various sources at a gateway, selecting network packets from the received network packets, and storing the selected network packets in a storage. The gateway is configured to select the network packets based on source and destination addresses of the network packets, based on a protocol of the network packets, based on a port designated, and based on whether a particular traffic session matches a predetermined signature.

### BRIEF DESCRIPTION OF THE DRAWINGS

The present invention will now be described in detail by describing illustrative, non-limiting embodiments thereof with reference to the accompanying drawings. In the drawings, the same reference characters denote analogous elements:

FIG. 1 is a block diagram illustrating a system for monitoring network traffic according to the related art.

FIG. 2 is a block diagram illustrating a system for monitoring network traffic according an illustrative, non-limiting embodiment of the present invention.

FIG. 3 is a block diagram of the storage device according to the exemplary embodiment of the present invention.

FIG. 4 is a block diagram of the logging device according to the exemplary embodiment of the present invention.

FIG. 5 is a structural diagram of a front panel of a logging device according to the exemplary embodiment of the present invention.

FIG. 6 is a perspective view of a graphical user interface for the network traffic analyzer according to the exemplary embodiment of the present invention.

FIG. 7 is a perspective view of a traffic viewer according to the exemplary embodiment of the present invention.

FIG. 8 is a perspective view of a configuration window for the traffic viewer according to the exemplary embodiment of the present invention.

FIG. 9 is a perspective view of the date filter for the traffic viewer according to the exemplary embodiment of the present invention.

FIG. 10 is a perspective view of the simple log search according to the exemplary embodiment of the present invention.

FIG. 11 is a perspective view of an advanced log search according to the exemplary embodiment of the present invention.

FIG. 12 is a perspective view of setting up a the network analyzer according to the exemplary embodiment of the present invention.

FIG. 13 is a perspective view of setting up a report scope according to the exemplary embodiment of the present invention.

FIG. 14 is a perspective view of setting up alert events according to the exemplary embodiment of the present invention.

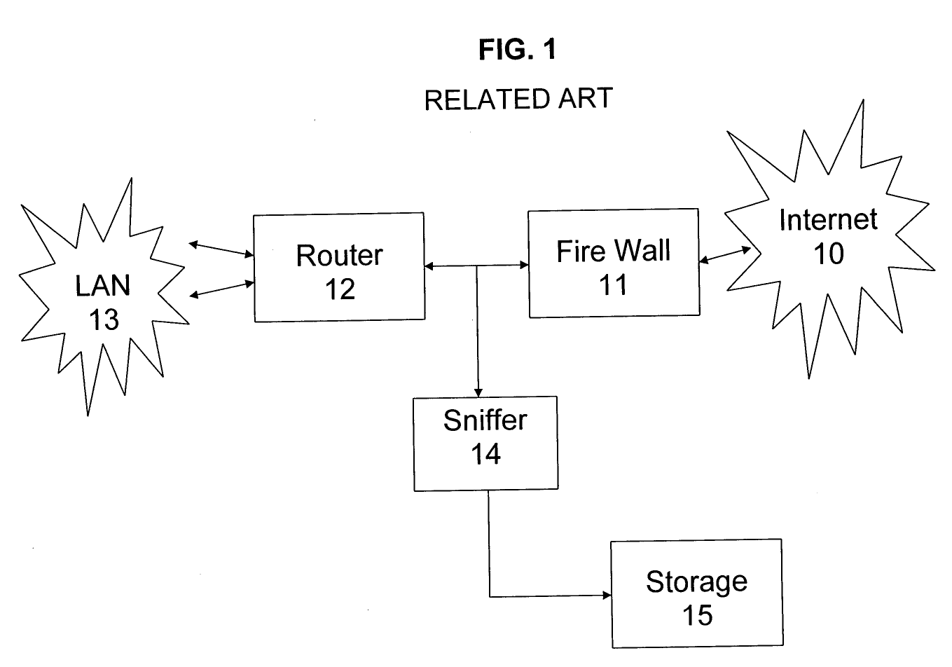

### DETAILED DESCRIPTION OF ILLUSTRATIVE, NON-LIMITING EMBODIMENTS

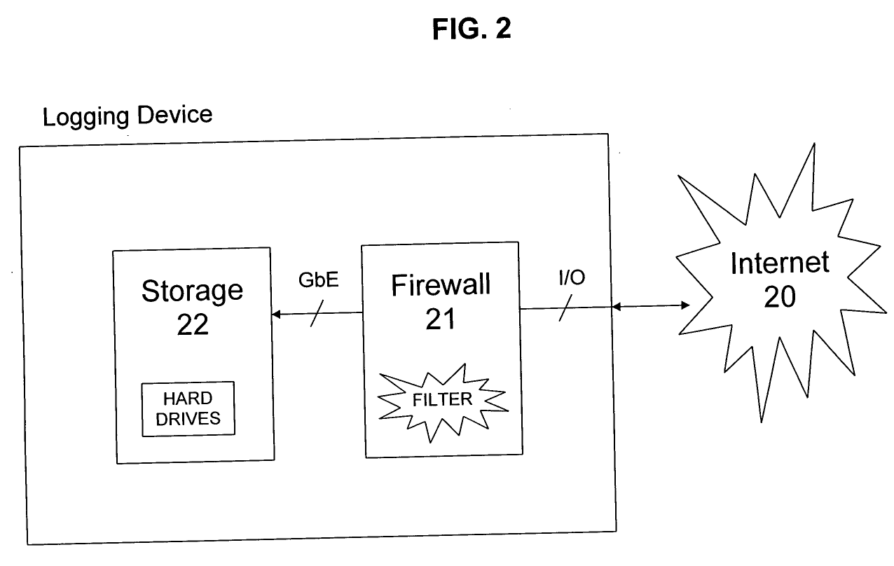

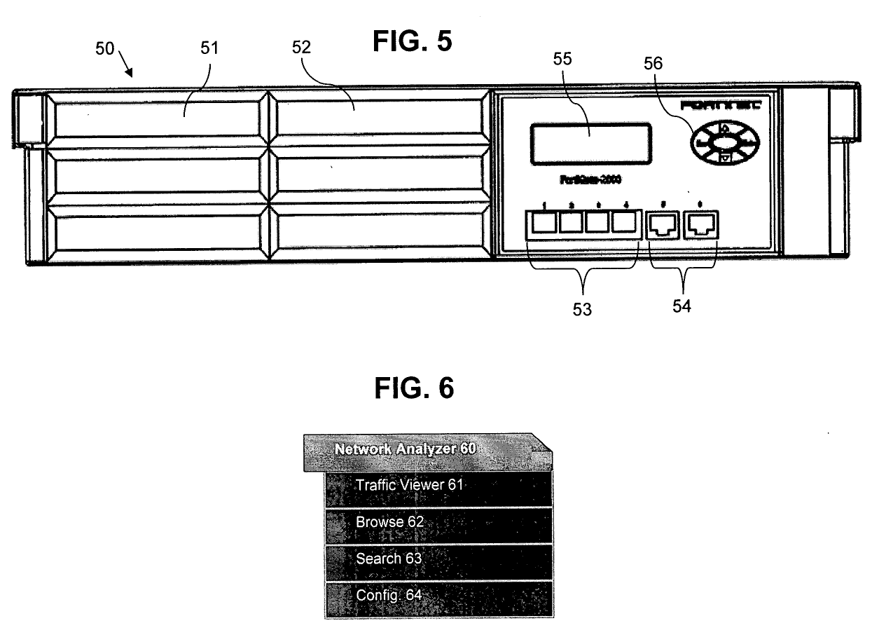

FIG. 2 depicts a block diagram of a logging device according to an illustrative, non-limiting embodiment of the present invention. The logging device depicted in FIG. 2 has a firewall module 21 and the storage module 22. These two modules are interconnected via one or more GbE (Gigabit Ethernet) connectors, for example. For the sake of simplicity, only one GbE connector is depicted in FIG. 2. In addition, the logging device may include a display unit (depicted in FIG. 5 and explained in greater detail below). The display unit may be located on the front panel of the logging device. Alternatively, the logging device may be connected to a monitor for displaying data to the user. The logging device having the logging and the analyzing capabilities may be integrated with a switch, a gateway, or a router.

As illustrated in FIG. 2, the incoming data, for example from the Internet 20, is met by the firewall 21. The firewall 21 may be located on a separate circuit board or can be on the same board with the storage 22.

The firewall 21 depicted in FIG. 2 is equipped with a filter module for filtering the incoming traffic. The software filter module can be user defined. For example, the user can decide which port on the gateway is to be monitored for the traffic, what traffic pattern (source and destination address or service) is to be sent to the storage device 22. The user may select traffic based on a protocol or format of the data packets or based on whether a particular traffic session matches a predefined signature. Any number of these exemplary criteria may be specified by a user in various combinations.

Moreover, the user can also specify the depth of logging. For example, the user can set the parameters so that only headers of the data packets are logged. Alternatively, the user can set the parameters to log the full content or only the session related data (length of the data). For example, the user may request that only the headers of the IP packets are logged and to log the entire packets for all other types of packets. For example, the user can set the designated parameters: a) by manipulating the front panel of the logging device, explained in greater detail below, b) by using a software application to connect to the logging device through a network to configure the desired parameters, and c) by using a serial cable to connect to a serial port on the front panel of the logging device, explained in greater detail below. As those skilled in the art will recognize, there are ways other than those examples identified above to connect to the logging device.

Accordingly, when a packet arrives at the firewall 21, the packet information such as source and destination address, format and so on is checked. In the example provided above, if the packet is an IP packet, then only its header is logged into the storage 22. That is, the firewall 21 serves as a filter recognizing the format of the packet and selecting the packets that are to be logged onto the storage 22. Moreover, the firewall informs the storage 22 of the type and content of the packets being stored, thereby facilitating the restoration of the messages, i.e., facilitating data analysis. For example, the user sets parameters on the front panel of the logging device depicted in FIG. 5 and the firewall 21 is informed of the set parameters using software instructions. In its turn, the firewall 21 informs the storage 22 of the parameters set by the user via the GbE connector.

That is, the firewall 21 selectively decides which network packets are to be stored in the storage 22 based on the user specified criteria and which packets can go through without the logging. By setting rules or filters for storing data packets further analysis of the data is facilitated. In other words, the firewall 21 is configured to select certain traffic types and then send those selected traffic types to the storage 22, while the unselected traffic will bypass the logging step. By way of a variation and not a limitation, the device 21 may be a switch or some other network gateway device. The traffic types may be selected based on source and destination addresses, based on protocol type of the packet or port numbers, and/or based on whether a particular traffic session matches a predefined signature. These criteria, any number of which can be selected, are provided by way of an example only and other criteria are within the scope of the invention.

In particular, the firewall 21 may include the following components: a processor to execute the firewall operations as well as the filtering operations discussed above and a memory. The memory of the firewall 21 may store user specified parameters and the processor may execute the required operation to filter the packets being sent to the storage device 22. As an alternative, the firewall 21 may include more than one processor.

Next, the data filtered by the firewall 21 is sent to the storage 22. The storage unit 22 receives the data from the firewall 21 and may store them on its persistent storage device such as a hard disk or a flash memory. The storage 22 has a processor or a controller controlling the storage of data as well as other operations. For example, by using a processor, the storage 22 can store data not only in the original packets but can also reconstruct data and store the application level data (like an email, a file download and so on) in the application format to facilitate sorting and searching. The processor of the storage 22 indexes or sorts the received data packet to facilitate further searching. The processor of the storage 22 may automatically overwrite portions of its old data to make room for the new data. When the firewall 21 and the storage 22 are integrated on the same circuit board, it is advantageous to provide at least two processors such as central processing units (CPUs) so that one processor controls the firewall operations and another processor controls the storage of the packets.

The storage 22 may also have a GbE controller that connects one port to the firewall 21 and another port to the front panel of the logging device. Alternatively, the storage 22 may be connected only to the firewall, as discussed above.

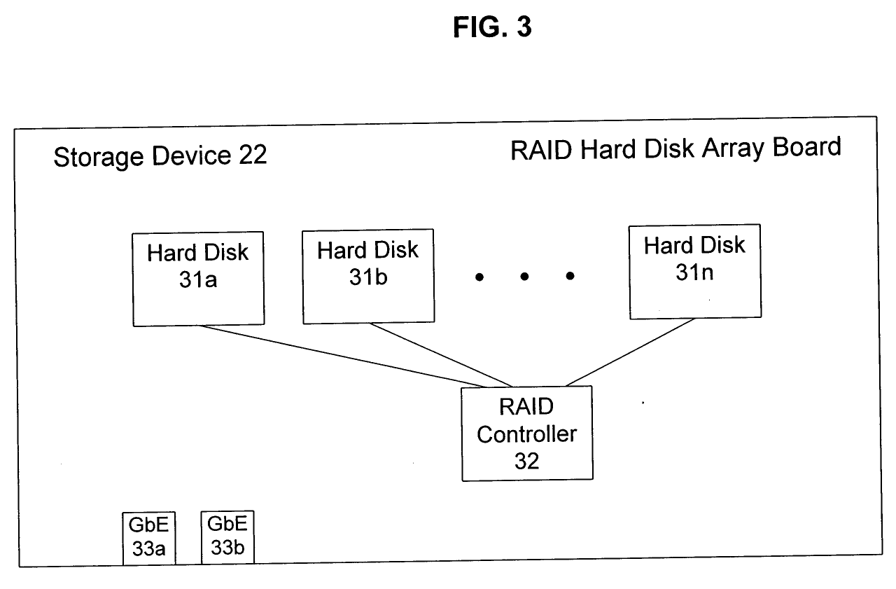

Moreover, the storage device 22 may include a number of memories, as depicted in FIG. 3. The exemplary storage device 22 may be a RAID (redundant arrays of inexpensive disks) hard disk array board that includes hard disks 31a, 31b, to 31n. Also the storage device 22 includes a RAID controller 32 and at least two or more GbE ports 33a and 33b. The RAID controller 32 receives packets via the GbE ports 33a and user requests via GbE port 33b, for example. In addition, the RAID controller 32 determines to which hard disk 31a, 31b, or 31n to transmit the received packets and transmits these received packets to the determined hard disk 31a, 31b, or 31n.

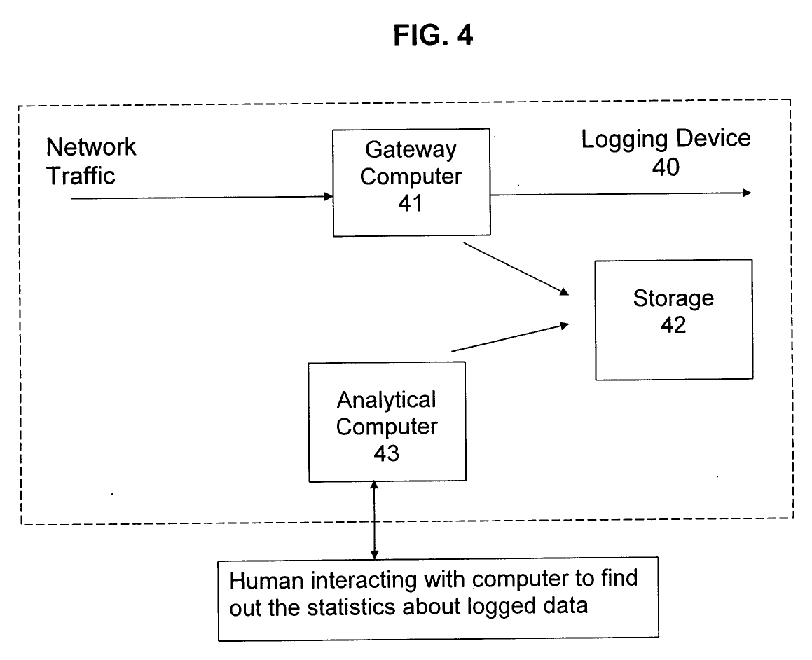

In the exemplary embodiment of the present invention, the logging device depicted in FIG. 4 includes a firewall and a storage area, as described above. That is, the logging device 40 includes a gateway computer 41. By way of an example, the gateway computer 41 may be a router, a switch, a hub with multiple network ports, or a firewall of some kind, as is known in the art. Moreover, the logging device 40 includes storage 42 such as a hard disk array depicted in FIG. 3 and an analytical computer 43. By way of a variation, the gateway computer 41 and the analytical computer 43 may be computing components such as CPUs integrated into one physical device.

A user, such as a network administrator, sets parameters for filtering the data by interacting, for example, with the analytical computer 43. It is possible, however, that the filtering parameters are set by directly configuring the gateway computer 41, as the gateway computer 41 often provides a way to filter the incoming data so that the user captures only the needed data and not each and every packet arriving at the gateway computer 41.

The network traffic is received by the gateway computer 41. The gateway computer 41 filters the data received using the parameters set by the user and sends the filter data to the storage 42. In the storage 42, the data is sent to a respective hard disk using a controller. That is, once the copies of the original packets are captured by the storage 42, the packets are then reconstructed and saved to a disk in their original format. Once the traffic has been capture and saved to disk, the user interacts with the analytical computer 43 to manipulate and structure the data stored in the storage 42. In accordance with the user requests, the analytical computer 43 connects to the storage 42 to retrieve and manipulate the data stored therein.

The logging device should have a user interface or may be connected to a user interface to allow users to look at the logs and search/sort data. The user interface may be provided on the front panel of the logging device 50, as depicted in FIG. 5. Specifically, the logging device 50 may include a set of primary hard disks 51 and a set of secondary or backup hard disks 52. The backup hard disks may be provided for redundancy. The logging device may include a number of ports 53 such as Ethernet ports 1, 2, 3, and 4. These ports 53 are used to connect to the devices being monitored i.e., the devices receiving the data that is sent to the logging device 50. Moreover, the logging device 50 may include a few management ports 54, such as ports 5 and 6 depicted in FIG. 5. These management ports 54 may connect the logging device 50 to a user interface such as a display monitor. Furthermore, the logging device 50 may itself include a display 55 and a panel 56 for accepting user input to configure the logging device 50.

The analytical computer 43 provides the user with a real-time and a historical display of the data stored in the storage 22. The user has the ability to filter the entries displayed. The user is also provided with an ability to set periodic scannings of the log files, to locate email, HTTP or FTP traffic, followed by reconstruction of the original message, which should be saved in the content log format.

Moreover, the user is provided with an ability to generate traffic related reports. That is, the analytical computer 43 may include reporting capability so that various reports can be generated, such as traffic pattern or security reports, described in greater detail below. The user may also search through the logged content by specifying a particular data type and a search word, for example. Moreover, the user may search by using the data size. Other criteria for user searches are possible and are within the scope of the invention.

In addition, the user can use an alerting mechanism. That is, the user may set automatic rules that will alarm the user to particular packets or messages, as described in greater detail below. The alerts can be set based on size, words, and/or patterns such as how quickly the storage is saving packets. Additionally, the user is provided with statistical information or records on how much data is stored on the media or the storage and how long the data will exist.

By way of an example, a view depicted in FIG. 6 may be provided for analyzing the stored traffic. The Network Analyzer 60 includes a traffic viewer 61, a browse item 62, a search item 63, and a configuration item 64. Moreover, the Network Analyzer 60 may include a report item and an alert item (not depicted). Each of these exemplary items 61-64 as well as the report item and the alert item is described in further detail below.

### Traffic Viewer

Upon selecting the traffic viewer 61, the user is provided with all the packets stored in the storage. That is, the user is provided with all of the traffic logged in the storage in a predetermined period of time by displaying these packets on the display. The traffic viewer may have two modes. One mode for viewing historical data, such as last years data, and another mode for viewing current data, such as network traffic for the past week.

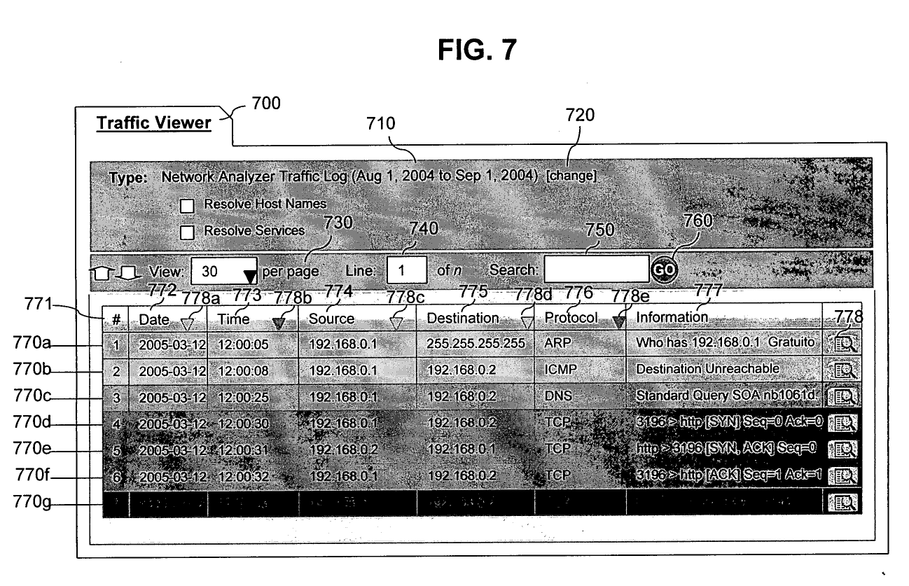

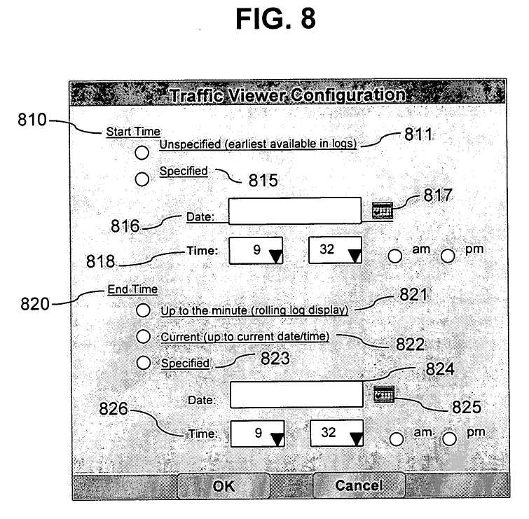

For example, when the user selects the traffic viewer 61, the traffic logged in the storage is displayed in the format depicted in FIG. 7. The traffic viewer 700 depicted in FIG. 7 displays data packets received in a predetermined time period 710 e.g., Aug. 1, 2004 to Sep. 1, 2004. That is, the traffic viewer 700 is in a historic mode. The time period 710 may be changed by selecting change item 720. When the user selects the change item 720, the wizard depicted in FIG. 8 helps the user to select the appropriate date ranges.

As depicted in FIG. 8, user specifies the start time 810 and the end time 820. With respect to the start time 810, the user may leave the start time unspecified 811. When the time is left unspecified, the earliest available in the storage will be displayed. When, on the other hand, it is determined to specify the start time 815, the settings date 816 and time 818 are manipulated to set the starting date and the time.

The user may further set the end time 820. In the example depicted in FIG. 8, three options are provided for setting the end time 820. The user may select rolling log display 821. When rolling log display 821 is selected, as the new traffic is coming in, it will be examined in accordance with the user specified parameters and displayed to the user when appropriate. That is, the rolling log display 821 is up to the minute display of the incoming traffic. The second option is to set the end time 820 to current 822. Accordingly, all of the incoming packets up to the date and time of the request will be displayed to the user provided, of course, these packets meet the user specified criteria. The third option is to specify the end time 823. In this setting, the user will specify the date 824 and the time 826 for the end time. Moreover, a calendar icons 817 and 825 are provided where the date may be selected from a pop up calendar.

The user may further select the number of entries (number of data packets) to view per page. As depicted in FIG. 7, number of entries to view 730 is set to thirty. Next, a view 740 is provided for showing the user which entry is currently being viewed. For instance, in FIG. 7, it is depicted that the user is viewing the first entry out of n entries. The user may search the entries by entering one or more key words in the search item 750 and pressing go item 760.

In the exemplary viewer 700, for each entry 770a . . . g (for each data packet) the following items are displayed: the number of the entry 771 (such as 1, 2, 3, . . . 7), date of arrival 772 (Mar. 12, 2005) and time of arrival 773 (hours, minutes, and second of arrival) to the gateway computer, a source 774 (IP address of the source host such as 192.168.01) where the respective packet originated, a destination 775 of the packet (IP address of the destination host such as 255.255.255.255), and the protocol 776 (the format of the packet such as Transmission Control Protocol (TCP), Address Resolution Protocol (ARP), Internet Control Message Protocol (ICMP), and Domain Name System (DNS)), and additional information 777. The additional information 777 may include items such as whether the packet reached its destination, type of message such as whether the message is a synchronization message and/or an acknowledgement message or whether a message is a query and so on. To view details of a desired entry (data packet), the user may simply click icon 778 and the contents of the packet along with other details may be displayed. The contents of the packet may be:

| | |
|---|---|
| [symbol] | Frame 1 (42 bytes on wire, 42 bytes captured) |
| [symbol] | Ethernet II, Src: 00:0b:5d:20:cd:02, Dst: ff:ff:ff:ff:ff:ff |
| [symbol] | Address Resolution Protocol (request/gratuitous ARP) |

| | | | | | | | | | | | | | | | | | | | |
|---|---|---|---|---|---|---|---|---|---|---|---|---|---|---|---|---|---|---|---|
| 0000 | ff | ff | ff | ff | ff | ff | 00 | 0b | 5d | 20 | cd | 02 | 08 | 06 | 00 | 01 | . . . . . . . . | | . . . . . . |
| | | | | | | | | | | | | | | | | | | {close oversize brace} | |
| 0010 | 08 | 00 | 06 | 04 | 00 | 01 | 00 | 0b | 5d | 20 | cd | 02 | c0 | ab | 00 | 02 | . . . . . . . . | | . . . . . . |
| 0020 | 00 | 00 | 00 | 00 | 00 | 00 | c0 | a8 | 00 | 02 | | | | | | | . . . . . . . . | . . | |

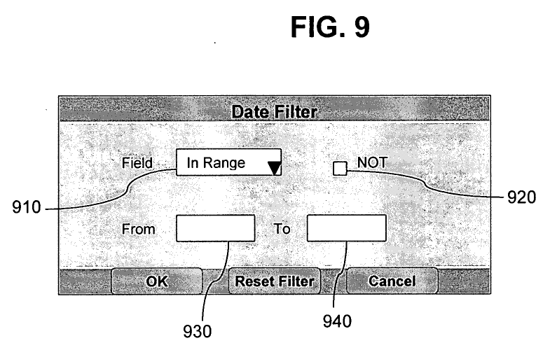

Moreover, additional filters may be designated for items 771 to 775, as depicted by icons 778a . . . e. That is, a filter may be set for each of these items 778a, 778b, 778c, 778d, and 778e. For example, the filter for the date may be set with the exemplary graphical user interface depicted in FIG. 9.

For example, as depicted in FIG. 9, the user may specify the range 910 by specifying before, after, or in range. Moreover, the user may specify not in range 920. For the before and after range 910, a date and time is set up, whereas for the in range both the date from 930 and the date to 940 may be specified. The time may also be specified (not shown).

Finally, as depicted in FIG. 7, the entries may be designated by color. Colors per each row (entry) are pre-determined based on the presumed security of the log entry. For example, standard HTTP requests (TCP) are low risk and may be represented in green, while duplicated TCP Ack messages are considered high risk and may be represented in red. Other packets presenting a medium security risk may be designated with a neutral color like blue. Packets whose security risk is unknown may be designated in white. Moreover, for user convenience, the numerical representations may be change to names via check boxes such as “resolve host names” and “resolve services,” as depicted in FIG. 7.

This exemplary viewer 700 depicted in FIGS. 7-9 is provided by way of an example only and is not intended to limit the scope of the invention in any way.

### Browse Item

Upon selecting the browse 62, the user is provided with all the packets stored in the storage. That is, the user is provided with all of the traffic logged in the storage in a predetermined period of time by displaying these packets on the display. The browse item 62 may have two or more modes. One mode may be for viewing historical data such as last years data and another mode may be for viewing current data such as network traffic for the past week. The browse item allows the user to browse through the displayed traffic one by one.

### Search Item

Upon selecting the search item 63, the user is provided with an option to search the traffic stored on the hard disks for various key words. In particular, two types of searches may be provided: basic search 1000 and advance search 1100.

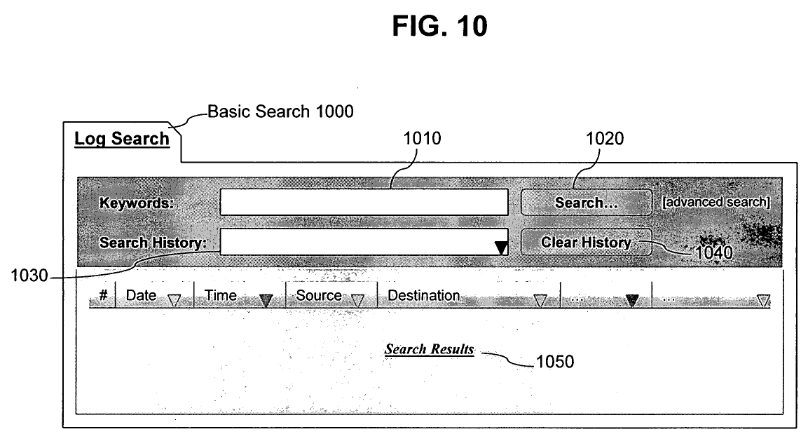

When the basic search 1000 is selected, an exemplary view is depicted in FIG. 10. In FIG. 10, the user designates one or more keywords 1010 and selects to search 1020. Once the search 1020 is selected, all the hard disks storing the traffic data are searched based on these keywords. The packets meeting the criteria specified in the search are displayed in the results portion 1050. The results portion 1050 allows for filtering the displayed traffic packets, somewhat similar to the display of the traffic viewer described above. The user is provided with an option to review the searches made by selecting a search history field 1030. The results of the previous search are depicted in the search result 1050. The user may also clear history of the searches by selecting clear history 1040.

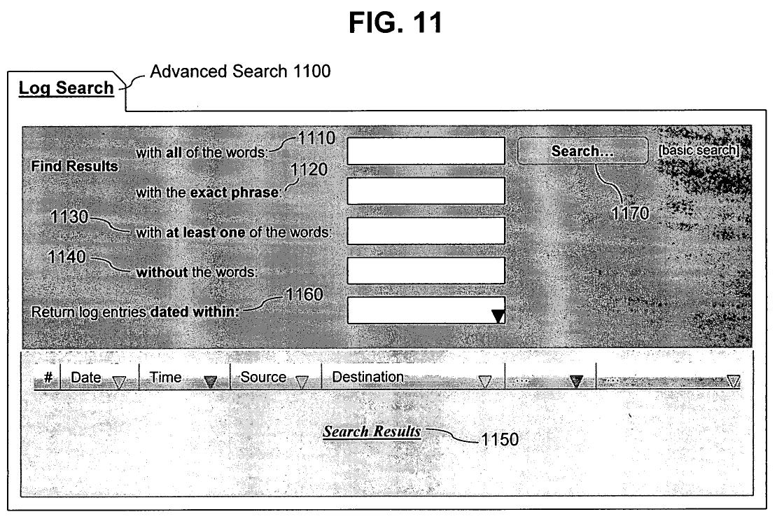

When the advanced search 1100 is selected, an exemplary view is depicted in FIG. 11. The advance search 1100 provides more options than the simple search 1000. For instance, it is possible to designate a keyword search with all the words input by the user 1110 or to search for an exact phrase 1120. Further, it is possible to implement a search for finding one of the entered words 1130 or to execute a search to find all of the logged traffic that does not contain a certain word or words (without the words 1140). Finally, the user may be provided with an option to set the dates of the desired data traffic (dated within 1160). When the user selects to set a date, a drop down menu may be provided. The user may specify last hour, last day, last week and so on. Once the search criteria is input into one or more of the fields 1110, 1120, 1130, 1140, and 1160, the user requests searching 1170 and the results are displayed in the result portion 1150, which is similar to the results portion 1050, depicted in FIG. 10 and described above.

When a search is being executed, a user is provided with a notification that a search is in progress. The results, however, are displayed as they are found in the system. That is, when a new packet meeting the user specified criteria is found, it is displayed in the results portion 1050 or 1150. The user may end the search at any time by selecting an appropriate item on a graphical user interface (not shown). For instance, when all of the desired packets are found by the user, the search may be stopped. This exemplary search item is provided by way of an example only and is not intended to limit the scope of the invention.

### Configuration Item

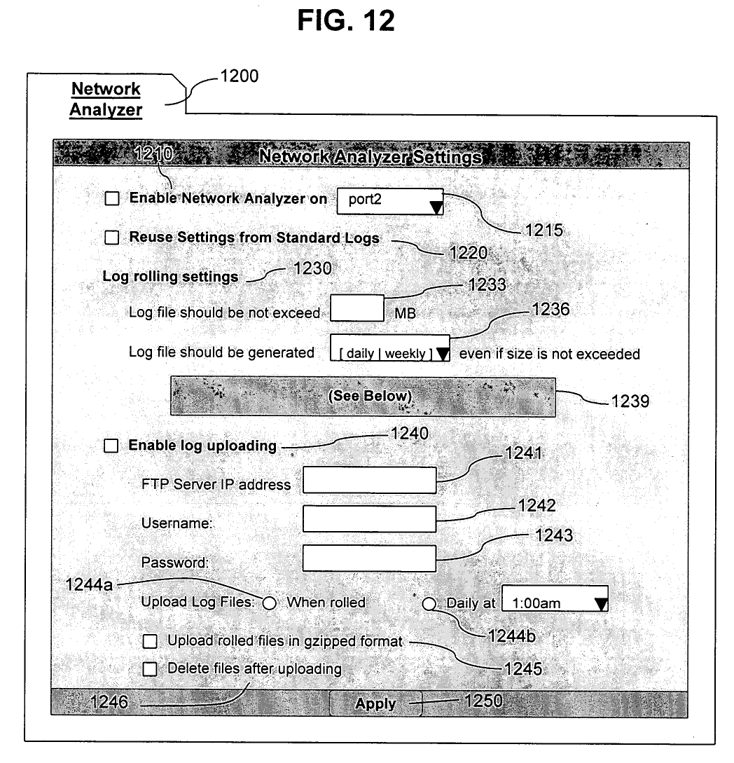

The user is provided with an additional flexibility of setting up the configurations of the network analyzer. By selecting the configuration item 64, an exemplary view 1200 of configuring and enabling the network analyzer is provided, as depicted in FIG. 12. The configuration item enables the analyzer as well as sets up the log rolling and the transferring or duplication of logs to a secondary or a backup device.

As depicted in FIG. 12, it is possible to enable or disable the analyzer by manipulating enable network analyzer 1210. When the analyzer is disabled, all other configurations are disabled. On the other hand, when the analyzer is enabled, a port to be analyzed should be designated by manipulating drop down item 1215 e.g., to designate port2. Furthermore, a reuse of the setting may be selected by manipulating reuse field 1220. When reuse of the setting is selected, other configuration settings disappear and the setting from the standard logs are user. Specifically, standard log setting are uploaded from another server, for example.

Moreover, the log rolling settings are adjusted by manipulating log rolling fields 1230. By way of an example, the size of the log file may be designated 1233 and when the log file should be generated may also be specified 1236. That is, in the view 1239, the user may set up certain calendar days and time for the monthly logs, certain days of the week and time for the weekly logs, or the time for the daily logs. Accordingly, the user sets up the frequency of the log rolling.

Moreover, log uploading may be enabled 1240. The log uploading occurs after the log rolling. To upload the files, IP address of the FTP server should be designated 1241 and for security username 1242 and password 1243 should be provided. It can be determined when to upload these files i.e., upload the files when they are rolled 1244a or at a predetermined time intervals such as daily at a certain time or times 1244b. Also, the format for uploading files may be specified such as upload in gzipped format 1245 and it may be designated to delete the files after uploading 1246. Once all the settings are specified, the settings are accepted via field 1250. This exemplary configuration item is provided by way of an example only and is not intended to limit the scope of the invention.

Moreover, the network analyzer 60 allows the generation of reports and setup of alarms or alerts. Reports and Alerts may appear as separate menu items in a graphical user interface menu. Upon selection of reports, the user may be provided with an option to configure or set up reports and to browse a collection of files under quarantine i.e., the files that may be considered to contain virus. Also, an option to browse the defined reports is provided.

When the user selects to configure or set up reports, a table of reports that are already defined are provided. The table may include report name such as “Daily-All” or “weekly”, devices from which these reports are generated such as all devices or devices in group 4, and information about when these reports are generated such as daily at 12 am or weekly on Mondays at 1 am. The table may also provide actions that may be taken with respect to the corresponding report. These actions may include deletion of a report, edit of a report, and generating or running a report. For example, by selecting the action “running a report,” the report may be generated on the fly as opposed to waiting for its scheduled time. The user may edit the defined reports and set up new reports.

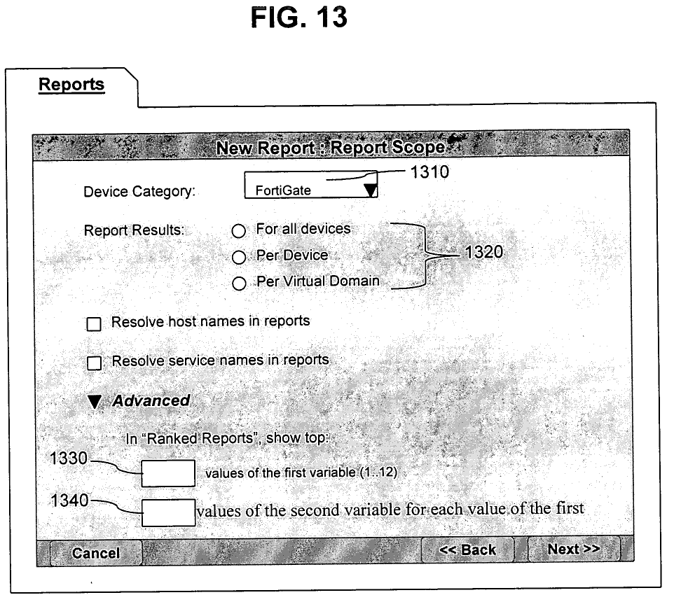

To generate a new report, the user selects an appropriate menu option. For each new report, the user specifies the name of the report, the time period for the report and a scope of the report. An exemplary graphical user interface for setting up the scope of the report is depicted in FIG. 13. As depicted in FIG. 13, a device category is specified at 1310. At 1320, the user may specify whether the report is to be generated for all devices, one report for each device, or one report for each virtual domain. For user convenience, the numerical values in the reports may be replaced with corresponding names. For example, the user may select to resolve host names and/or resolve service names in the reports. Moreover, advanced set up option may be provided, as depicted in FIG. 13. That is, the generated report may be ranked by manipulating items 1330 and 1340.

Moreover, the user may set up a group of reports. In setting up a group of reports, the user may select a basic set for generating most commonly used reports, all possible reports set, and a custom set of reports. For example, when a basic or standard set of reports is selected, the report types that apply, automatically selected from of all possible report types, are automatically checked and the other ones are grayed out. Alternatively, when the user selects to generate all possible reports, all of the boxes are automatically checked. When the custom set of reports is selected, the user specifies which reports should be included in the custom set. That is, the user selects from all possible reports which ones should be generated.

By way of an example, the following types of reports may be generated: a) monitor network activity, b) monitor web activity, c) monitor file transfer protocol (FTP) activity, d) monitor terminal activity, e) monitor mail activity, f) monitor intrusion activity, g) monitor anti-virus activity, h) monitor web filter activity, i) monitor mail filter activity, j) monitor virtual private network (VPN) activity, and k) monitor content activity. This list is provided by way of an example only and is not intended to limit the scope of the invention. Monitoring other activities of the network are within the scope of the invention. Accordingly, if the listed reports a-j are all possible reports that may be generated, when the user selects to generate all possible reports, all reports described above (items a-j) will be generated. A standard or basic set of reports may be predefined to include only items a-c, f, and g, for example. When the uses selects a custom set, the user will select any number of items a-j.

For each of the items that may be selected in generating a custom set of reports, the user may also specify: 1) monitoring traffic by date and direction, 2) monitoring traffic by day of the week and direction, and 3) monitoring traffic by hour of the day and direction and so on. A default may also be providing, e.g., monitor all incoming traffic.

The user may also be provided with an option to set up a filter log, similar to the set up of filter logs described above. Next, the user may specify when the report should be generated such as daily at 3:00 am and the desired output format. For example, the output format for a file or an email may be specified. For example, the file may be saved or the email may be sent in formats such as text, pdf, MS Word, HTML, or some other format. Moreover, email addresses to where the reports should be emailed are specified.

To edit existing reports, a menu with various categories or characteristics of the reports are provided such as time period, report scope, report selection, devices, filter, schedule, and output. The user selects a category or the characteristic for editing and proceeds with the edits.

The Network Analyzer according to an exemplary, non-limiting embodiment of the present invention further allows a set up of alarms or alerts. The alerts or alarms watch for a particular event or action and respond in a predetermined way once the event or action occurs. Setting up alerts in the exemplary embodiment includes identifying devices to be monitored and setting up alert triggers. First, the devices that are to be monitored for alerts are identified. For example, as explained above with respect to the Reports, the user may designate all devices, a particular group or category of devices, or just a single device. Next, the alert events are set up. Alert events are triggers or conditions that turn on an alert, e.g., a condition that triggers sending an alarm notification to a specific device. Also, actions or responses that should be taken when the monitored event occurs may be set up.

When the user selects alerts, a list of the defined alerts or alarms is displayed. For each set up alert events, a name of the alert, devices monitored, triggers and actions or a response when the event or trigger occur are displayed. For example, an alert event may be an event log or a virus and the action or response may be to email a specified person.

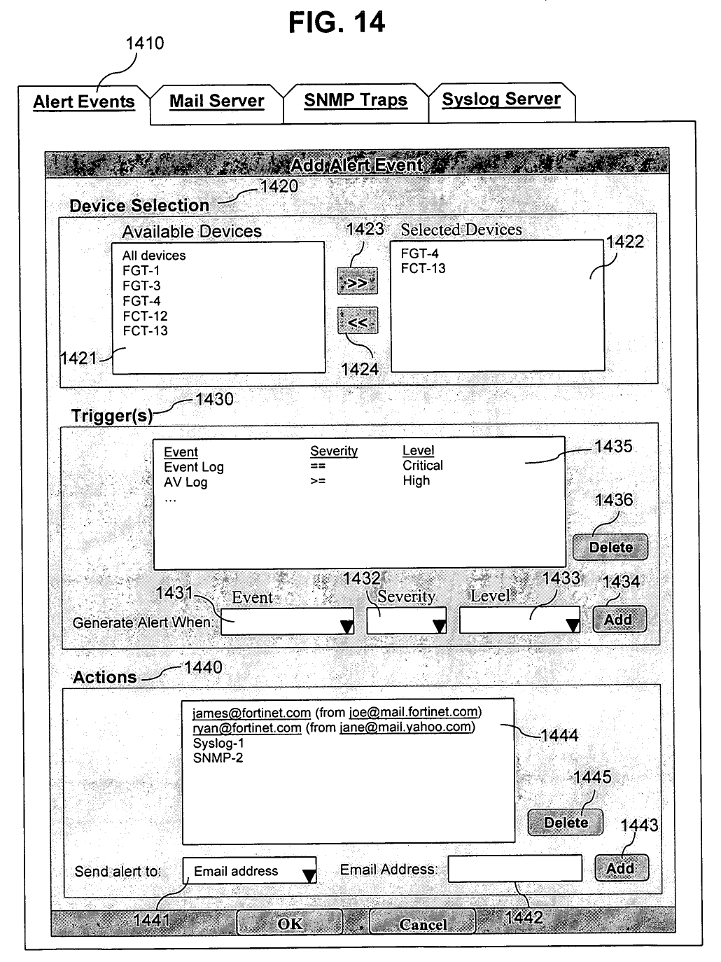

An alert event may be added or edited on the fly via an exemplary view depicted in FIG. 14. To add an alert event 1410, the user selects devices 1420 for the alert event. Specifically, the user may simply select devices from the list 1421 and places them in a list of selected devices 1422 or unselect devices via arrow items 1423 and 1424. The user also specifies a trigger or a number of triggers 1430. For example, a user may select from an event via 1431 such as an event log or an authenticity verification log, the user may also select severity 1432 and the level 1433. The user may also add a new event and specify its level and severity by manipulating 1431, 1432, 1433, and an add item 1434. The list of defined triggers 1435 may be displayed. The user may select a trigger for the list 1435 and delete 1436 the selected trigger. The user may also specify actions or responses 1440. For example, a user may select 1441 an email address where the alert should be sent or may add an email address to where an alert should be sent by, for example, inputting an email address into an item 1442 and selecting to add 1443 the address. A list of defined actions or responses 1444 may be provided. The list 1444 may include emails where the alert should be sent such as email destination and source addresses and servers that should be notified such as Syslog-1 and SNMP-2. Also, a user may delete a response from the list using delete item 1445. Also, a user may set up various servers such as mail servers, SNMP servers, and system servers via tabs depicted in FIG. 14. Accordingly, various alarms or alerts may be set up to notify a user in an event of failure, possible virus attacks and so on. The user may set up desired alerts on the fly via user friendly dialog boxes.

According to the illustrative embodiment of the present invention, some gateway device such as a firewall or a switch selectively send traffic to a logging device. The traffic may be filtered based on any number of criteria such as source and destination addresses, traffic protocol and port numbers, and predefined signatures (e.g., whether a predefined signature matches a particular traffic session). The user sets up the criteria for the filtering on the fly. The filtered data is stored in a storage device and another device analyzes the filtered data. For example, various searches may be performed on the stored data, reports may be generated and alerts or alarms may be set up.

The gateway device and the analyzing device may simply be two computing components and a storage device may be a single storage component within one device. The gateway component will write the data or packets to the storage component. In the mean time, the analyzing component may sort and analyze the data on the fly providing an efficient way to monitor network traffic in real time.

The above and other features of the invention including various novel method steps and a system of the various modules and an apparatus of various novel components have been particularly described with reference to the accompanying drawings and pointed out in the claims. It will be understood that the particular process and construction of parts embodying the present invention is shown by way of illustration only and not as a limitation of the invention. The principles and features of this invention may be employed in varied and numerous embodiments without departing from the spirit and scope of the invention as defined by the appended claims.

What is claimed is:

1. A logging device managing network packets, the logging device comprises:
a traffic capturing component receiving network packets and filtering the received network packets by selecting those network packets that satisfy a predefined criteria;
a storage component storing the selected network packets; and
an analyzing component organizing the stored network packets in accordance with at least one user specified parameters,
wherein the traffic capturing component, the storage component, and the analyzing component are integrated in a single physical device.

2. The logging device according to claim 1, wherein the traffic capturing component and the analyzing component, each comprises at least one processor.

3. The logging device according to claim 1, wherein the storage component comprises a plurality of Redundant Arrays of Independent Disks (RAID) hard drives and a RAID controller determining to which of the plurality of RAID hard drives an incoming network packet should be saved.

4. The logging device according to claim 3, wherein the storage component is connected to at least one of the traffic capturing component and the analyzing component and wherein the traffic capturing component is one of a firewall, a gateway computer, and a switch.

5. The logging device according to claim 1, further comprises: a display and a user interface, wherein the predefined criteria for filtering the network packets is specified via the user interface, and wherein said predefined criteria for selecting the network packets comprises designating at least one of: a source address, a destination address, a protocol, a port, and a predefined signature that corresponds to a specific traffic session.

6. The logging device according to claim 5, wherein, when a user inputs the predefined criteria via the user interface, and the traffic capturing component automatically and on-the-fly adjusts the selection of the network packets based on the received user input.

7. The logging device according to claim 1, wherein the selection of the network packets based on said predefined criteria comprises selecting network packets whose predefined signature matches a specific traffic session.

8. The logging device according to claim 1, wherein the selection of the network packets based on said predefined criteria comprises selecting network packets whose predefined signature matches a specific traffic session, and wherein the predefined criteria further comprises designation at least one portion of the network packet for the storing in the storage component.

9. The logging device according to claim 1, wherein the analyzing component provides a list of network packets from the stored network packets that matches the at least one user specified parameter that comprises at least one of: a selection of alphanumeric characters present in a content of the network packet, a selection of alphanumeric characters absent from the content of the network packet, a network protocol, time, and date, and wherein the analyzing component provides the network packets that match the at least one user specified parameter with an indication of a security level for each of the presented network packets.

10. The logging device according to claim 1, wherein the analyzing component generates at least one report based on the user specified parameters that comprise at least one of: a time period when the at least one report is generated, a designation of at least one device for which the at least one report is generated, a designation of a rank of the at least one report and a designation of a report type.

11. The logging device according to claim 10, wherein report types comprise all reports, a basic set of said all reports and a custom set of reports where a user selects at least one report from said all reports, wherein said all reports comprise network activity report, web activity report, file transfer protocol report, terminal activity report, mail activity report, intrusion activity report, anti-virus activity report, web filter activity report, mail filter activity report, virtual private network activity report, and content activity report and wherein for each report from said all reports a time period and a direction of the network packets is designated.

12. The logging device according to claim 11, wherein the at least one user specified parameter further comprises designating output format of a report.

13. The logging device according to claim 1, wherein the analyzing component sets up at least one alert based on the user specified parameters that comprise designating at least one device for monitoring, and designation a trigger event and a response.

14. The logging device according to claim 13, wherein the trigger event comprises an event type and a ranking level and wherein the response comprises notifying a server or sending an email to a predefined destination.

15. A logging system managing network packets, the logging system comprises:
a gateway computer receiving the network packets, the gateway computer is configured to select some the received network packets based on: a source address of a network packet, a destination addresses of the network packet, a protocol of the network packet, a port selection, and whether a specific traffic session matches a predefined signature of the network packet;
a storage device storing the selected network packets; and
an analyzing computer organizing the stored network packets in accordance with a user specified parameters.

16. The logging system according to claim 15, wherein:
the gateway computer is one of a switch and a firewall computer,
the storage device comprises a plurality of Redundant Arrays of Independent Disks (RAID) hard drives and a RAID controller determining to which of the plurality of RAID hard drives an incoming network packet is saved, and
the storage device is connected to at least one of the gateway computer and the analyzing computer.

17. The logging system according to claim 15, wherein the user specified parameters comprise at least one of a keyword, a keyword to exclude, a network protocol, time, date, exact phrase to appear in a content the analyzing component, and wherein the analyzing component presents network packets that match the user specified parameters indicating a security level for each of the presented network packets.

18. The logging system according to claim 15, wherein the analyzing computer generates at least one report based on the user specified parameters that comprise: a time period when the at least one report is generated, a designation of at least one device for which the at least one report is generated, a designation of a rank of the at least one report and a designation of a report type.

19. The logging system according to claim 18, wherein report types are all reports, a basic set of said all reports and a custom set of reports where a user selects at least one report from said all reports, wherein said all reports comprise network activity report, web activity report, file transfer protocol report, terminal activity report, mail activity report, intrusion activity report, anti-virus activity report, web filter activity report, mail filter activity report, virtual private network activity report, and content activity report and wherein for each report from said all reports a time period and a direction of the network packets is designated.

20. The logging system according to claim 19, wherein the user specified parameters further comprise designating output format of a report.

21. The logging system according to claim 15, wherein the analyzing computer sets up at least one alert based on the user specified parameters that comprise designating at least one device for monitoring, designating a trigger event and a response.

22. The logging system according to claim 21, wherein the trigger event comprises an event type and a ranking level and wherein the response comprises notifying a server or sending an email to a predefined destination.

23. The logging system according to claim 15, wherein the gateway computer is configured to select some of the received network packets based on a user input of at least one of: the source address of the network packet, the destination addresses of the network packet, the protocol of the network packet, the port selection, and the predefined signature, and wherein, when the user input is received, the gateway computer adjusts in real-time the selection criteria based on the received user input.

24. A method for managing network packets comprising:
receiving network packets from various sources at a gateway;
selecting network packets from the received network packets; and
storing the selected network packets in a storage, wherein the gateway is configured to select the network packets based on source and destination addresses of the network packets, based on a protocol of the network packets,
based on a port designated, and based on whether a particular traffic session matches a predetermined signature.

25. The method according to claim 24, further comprising analyzing the stored network packets, wherein said analyzing comprises building up indexes for the stored network packets.

26. The method according to claim 24, further comprising analyzing the stored network packets based on a user supplied criteria, wherein said analyzing comprises searching and browsing through the stored network packets, reproducing original content of the stored network packets, and generating reports of the network traffic based on the user supplied criteria, and setting up alarms in accordance with the user supplied criteria.

27. The method according to claim 24, wherein parameters for selecting the network packets by the gateway are designated by a user.
